(19) United States
(12) Patent Application Publication
(10) Pub. No.: US 2003/0163807 A1
(43) Pub. Date: Aug. 28, 2003

(54) Weighted selection of target systems for distributed software installation

(75) Inventors: Daniel R. Drake, Apex, NC (US); Thomas R. Haynes, Apex, NC (US); Robert C. Sizemore, Fuquay-Varina, NC (US)

Correspondence Address: Gerald R. Woods, IBM Corporation T81/503, PO Box 12195, Research Triangle Park, NC, 27709, US

(73) Assignee: International Business Machines Corporation, Armonk, NY (US)

(21) Appl. No.: 10/084,032

(22) Filed: Feb. 27, 2002

(51) Int. Cl. G06F 9/445

(52) U.S. Cl. 717/174

(57) ABSTRACT

Methods, systems, and computer program products for programmatically generating a ranked list of suitable target systems for a particular product-specific software installation, using a generic approach that is easily adaptable to a wide variety of software products. Product-specific configuration parameters and corresponding weights are used in performing the suitability assessment, and routines are identified which may be invoked on potential target systems to determine values of the configuration parameters. The weights are then applied to values representing each potential target system, and the summed total represents the suitability of that potential target. A ranked list may then be created and provided to the software installer for use in selecting the actual target(s) of the installation. In preferred embodiments, structured markup language syntax is used to specify the configuration parameters and weights, as well as the identification of the routines.

### RELATED INVENTIONS

The present invention is related to U.S. patent ______ (Ser. No. 09/669,227, filed Sept. 25, 2000), titled “Object Model and Framework for Installation of Software Packages Using JavaBeans™”: U.S. patent ______ (Ser. No. 09/707,656, filed Nov. 7, 2000), titled “Object Model and Framework for Installation of Software Packages Using Object Descriptors”; U.S. patent ______ (Ser. No. 09/707,545, filed )Nov. 7, 2000, titled “Object Model and Framework for Installation of Software Packages Using Object REXX”; U.S. patent ______ (Ser. No. 09/707,700, filed Nov. 7, 2000), titled “Object Model and Framework for Installation of Software Packages Using Structured Documents”; U.S. patent ______ (Ser. No. 09/879,694, filed Jun. 12, 2001), titled “Efficient Installation of Software Packages”; U.S. patent ______ (Ser. No. 09/930,325, filed Aug. 15, 2001) titled “Run-Time Rule-Based Topological Installation Suite”; and U.S. patent ______ (Ser. No. 09/930,359, filed Aug. 15, 2001), titled “Extending Installation Suites to Include Topology of Suite's Run-Time Environment”. These inventions are commonly assigned to the International Business Machines Corporation (“IBM”) and are hereby incorporated herein by reference.

### BACKGROUND OF THE INVENTION

1. Field of the Invention

The present invention relates to a computer system, and deals more particularly with methods, systems, and computer program products for improving the installation of software packages by programmatically ranking weighted installation information in terms of candidate target systems.

2. Description of the Related Art

Use of computers in today's society has become pervasive. The software applications to be deployed, and the computing environments in which they will operate, range from very simple to extremely large and complex. The computer skills base of those responsible for installing the software applications ranges from novice or first-time users, who may simply want to install a game or similar application on a personal computer, to experienced, highly-skilled system administrators with responsibility for large, complex computing environments. The process of creating a software installation package that is properly adapted to the skills of the eventual installer, as well as to the target hardware and software computing environment, and also the process of performing the installation, can therefore be problematic.

In recent decades, when the range of computing environments and the range of user skills was more constant, it was easier to target information on how software should be installed. Typically, installation manuals were written and distributed with the software. These manuals provided textual information on how to perform the installation of a particular software application. These manuals often had many pages of technical information, and were therefore difficult to use by those not having considerable technical skills. “User-friendliness” was often overlooked, with the description of the installation procedures focused solely on the technical information needed by the software and system.

With the increasing popularity of personal computers came a trend toward easier, more user-friendly software installation, as software vendors recognized that it was no longer reasonable to assume that a person with a high degree of technical skill would be performing every installation process. However, a number of problem areas remained because of the lack of a standard, consistent approach to software installation across product and vendor boundaries. These problems, which are addressed in the related inventions, will now be described.

The manner in which software packages are installed today, and the formats of the installation images, often varies widely depending on the target platform (i.e. the target hardware, operating system, etc.), the installation tool in use, and the underlying programming language of the software to be installed, as well as the natural language in which instructions are provided and in which input is expected. When differences of these types exist, the installation process often becomes more difficult, leading to confusion and frustration for users. For complex software packages to be installed in large computing systems, these problems are exacerbated. In addition, developing software installation packages that attempt to meet the needs of many varied target environments (and the skills of many different installers) requires a substantial amount of time and effort.

One area where consistency in the software installation process is advantageous is in knowing how to invoke the installation procedure. Advances in this area have been made in recent years, such that today, many software packages use some sort of automated, self-installing procedure. For example, a file (which, by convention, is typically named “setup.exe” or “install.exe”) is often provided on an installation medium (such as a diskette or CD-ROM). When the installer issues a command to execute this file, an installation program begins. Issuance of the command may even be automated in some cases, whereby simply inserting the installation medium into a mechanism such as a CD-ROM reader automatically launches the installation program.

These automated techniques are quite beneficial in enabling the installer to get started with an installation. However, there are a number of other factors which may result in a complex installation process, especially for large-scale applications that are to be deployed in enterprise computing environments. For example, there may be a number of parameters that require input during installation of a particular software package. Arriving at the proper values to use for these parameters may be quite complicated, and the parameters may even vary from one target machine to another. There may also be a number of prerequisites and/or co-requisites, including both software and hardware specifications, that must be accounted for in the installation process. There may also be issues of version control to be addressed when software is being upgraded. An entire suite or package of software applications may be designed for simultaneous installation, leading to even more complications. In addition, installation procedures may vary widely from one installation experience to another, and the procedure used for complex enterprise software application packages may be quite different from those used for consumer-oriented applications.

Furthermore, these factors also affect the installation package developers, who must create installation packages which properly account for all of these variables. Prior art installation packages are often created using vendor-specific and product-specific installation software. Adding to or modifying an installation package can be quite complicated, as it requires determining which areas of the installation source code must be changed, correctly making the appropriate changes, and then recompiling and retesting the installation code. End-users may be prevented from adding to or modifying the installation packages in some cases, limiting the adaptability of the installation process. The lack of a standard, robust product installation interface therefore results in a labor-intensive and error-prone installation package development procedure.

Other practitioners in the art have recognized the need for improved software installation techniques. In one approach, generalized object descriptors have been adapted for this purpose. example is the Common Information Model (CIM) standard promulgated by The Open Group™ and the Desktop Management Task Force (DTMF). The CIM standard uses object descriptors to define system resources for purposes of managing systems and networks according to an object-oriented paradigm. However, the object descriptors which are provided in this standard are very limited, and do not suffice to drive a complete installation process. In another approach, system management functions such as Tivoli® Software Distribution, Computer Associates Unicenter TNG®, Intel LANDesk® Management Suite, and Novell ZENWorks™ for Desktops have been used to provide a means for describing various packages for installation. Unfortunately, these descriptions lack cross-platform consistency, and are dependent on the specific installation tool and/or system management tool being used. In addition, the descriptions are not typically or consistently encapsulated with the install image, leading to problems in delivering bundle descriptions along with the corresponding software bundle, and to problems when it is necessary to update both the bundle and the description in a synchronized way. (The CIM standard is described in “Systems Management: Common Information Model (CIM)”, Open Group Technical Standard, C804 ISBN 1-85912-255-8, August 1998. “Tivoli” is a registered trademark of Tivoli Systems Inc. “Unicenter TNG” is a registered trademark of Computer Associates International, Inc. “LANDesk” is a registered trademark of Intel Corporation. “ZENWorks” is a trademark of Novell, Inc.)

The related inventions teach use of an object model and framework for software installation packages and address many of these problems of the prior art, enabling the installation process to be simplified for software installers as well as for the software developers who must prepare their software for an efficient, trouble-free installation, and define several techniques for improving installation of software packages. While the techniques disclosed in the related inventions provide a number of advantages and are functionally sufficient, there may be some situations in which the techniques disclosed therein may be improved upon.

### SUMMARY OF THE INVENTION

An object of the present invention is to provide an improved technique for installation of software packages.

It is another object of the present invention to provide this technique using a model and framework that provides for a consistent and efficient installation across a wide variety of target la installation environments, where a programmatic ranking of weighted installation information is performed in order to recommend a target system to an installer.

Another object of the present invention is to provide a software installation technique that programmatically recommends one or more preferred installation targets.

Still another object of the present invention is to provide the improved software installation technique wherein weighted values of various installation parameters related to a target environment are used to programmatically rank candidate systems, prior to building and deployment of an installation package.

A further object of the present invention is to assist a software installer in selecting target systems.

Yet another object of the present invention is to provide this assistance by programmatically determining the suitability of candidate target systems, based on values corresponding to weighted installation parameters.

Other objects and advantages of the present invention will be set forth in part in the description and in the drawings which follow and, in part, will be obvious from the description or may be learned by practice of the invention.

To achieve the foregoing objects, and in accordance with the purpose of the invention as broadly described herein, the present invention provides methods, systems, and computer program products for improving installation of software packages by programmatically determining the suitability of candidate target systems. In one embodiment, this technique comprises: assigning a weight to each of one or more selected values of one or more installation parameters associated with a software product installation; determining a plurality of potential target systems on which the software product installation might be performed; identifying a routine to analyze each of the installation parameters; programmatically interrogating each of the potential target systems for its status of each of the installation parameters, using the identified routines; and using the assigned weights, in combination with the selected values and the status of each of the installation parameters, to compute a suitability assessment for each of the potential target systems. The programmatic interrogation preferably further comprises invoking the identified routines at each of the potential target systems (e.g. by transmitting a message to each of the potential target systems, wherein the message specifies the identified routines). Computing the suitability assessment preferably further comprises: comparing the status of each of the installation parameters to the selected values to determine the associated weight to be used for this installation parameter for this potential target system; and adding the determined weights.

The technique also preferably further comprises ranking the potential target systems according to their suitability assessments. This ranking may be provided to a software installer. The software installer preferably uses the provided ranking to select one or more of the potential target systems as one or more actual target systems for the software product installation.

A structured markup language is preferably used for specifying the assigned weights, the selected values, and the identifications of the routines. This specification is preferably part of an installation object defined for the software product installation.

The technique may further comprise distributing a software installation package for the software product installation to each of the selected actual target systems, and performing the software product installation on the selected actual target systems.

The present invention will now be described with reference to the following drawings, in which like reference numbers denote the same element throughout.

### BRIEF DESCRIPTION OF THE DRAWINGS

FIG. 1 is a block diagram of a computer hardware environment in which the present invention may be practiced;

FIG. 2 is a diagram of a networked computing environment in which the present invention may be practiced;

FIG. 3 depicts a sample target environment, and is used to illustrate advantages of the present invention;

FIG. 4 depicts a flowchart illustrating logic with which preferred embodiments of the present invention may be implemented;

FIG. 5 provides a sample structured markup language document fragment, showing how the variables and weights to be used by an implementation may be specified;

FIG. 6 illustrates an object model that may be used for defining software components to be included in an installation package, according to the related inventions, and which may be leveraged by the present invention;

FIG. 7 depicts an object model that may be used for defining a suite, or package, of software components to be installed, according to the related inventions, and which may be leveraged by the present invention; and

FIGS. 8 and 9 depict resource bundles that may be used for specifying various types of product and variable information to be used during an installation, according to an embodiment of the related inventions.

### DESCRIPTION OF PREFERRED EMBODIMENTS

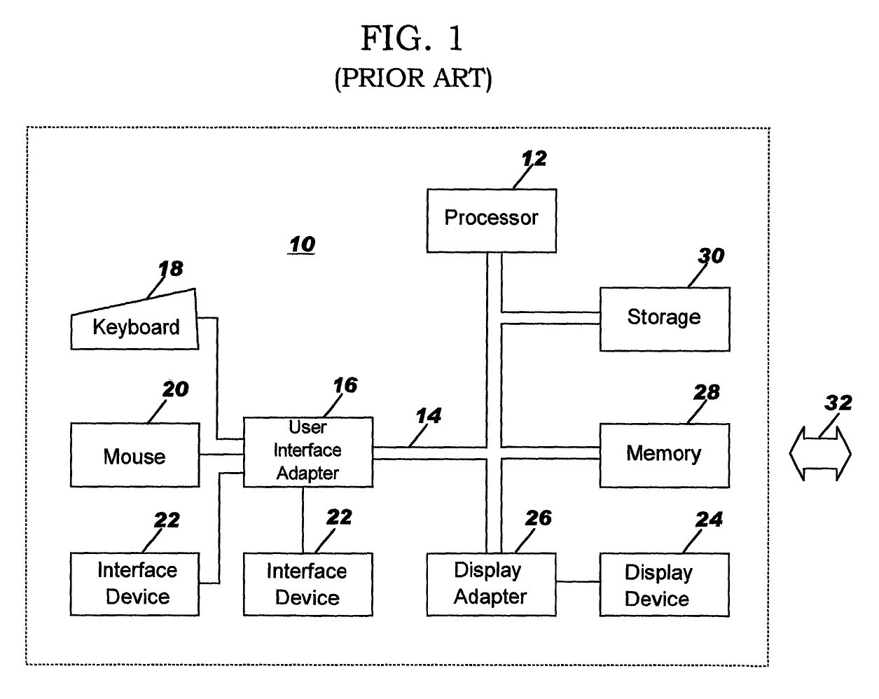

FIG. 1 illustrates a representative computer hardware environment in which the present invention may be practiced. The device 10 illustrated therein may be a personal computer, a laptop computer, a server or mainframe, and so forth. The device 10 typically includes a microprocessor 12 and a bus 14 employed to connect and enable communication between the microprocessor 12 and the components of the device 10 in accordance with known techniques. The device 10 typically includes a user interface adapter 16, which connects the microprocessor 12 via the bus 14 to one or more interface devices, such as a keyboard 18, mouse 20, and/or other interface devices 22 (such as a touch sensitive screen, digitized entry pad, etc.). The bus 14 also connects a display device 24, such as an LCD screen or monitor, to the microprocessor 12 via a display adapter 26. The bus 14 also connects the microprocessor 12 to memory 28 and long-term storage 30 which can include a hard drive, diskette drive, tape drive, etc.

The device 10 may communicate with other computers or networks of computers, for example via a communications channel or modem 32. Alternatively, the device 10 may communicate using a wireless interface at 32, such as a CDPD (cellular digital packet data) card. The device 10 may be associated with such other computers in a local area network LAN) or a wide area network (WAN), or the device 10 can be a client in a client/server arrangement with another computer, etc. All of these configurations, as well as the appropriate communications hardware and software which enable their use, are known in the art.

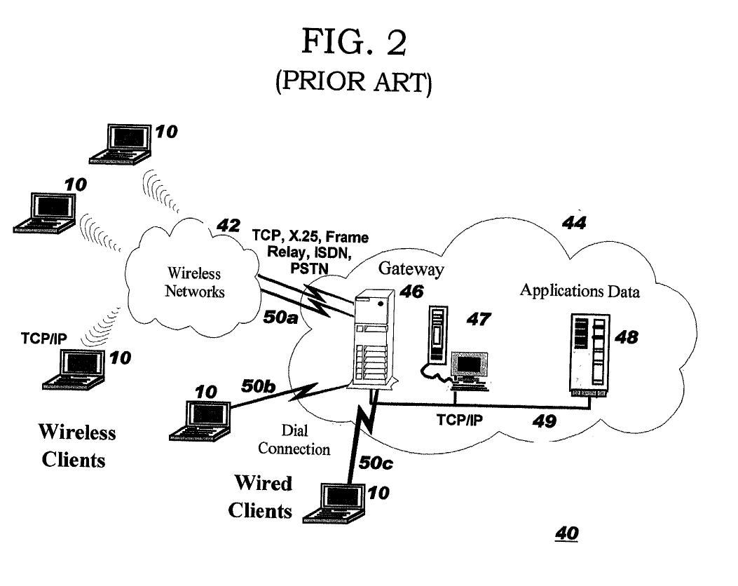

FIG. 2 illustrates a data processing network 40 in which the present invention may be practiced. The data processing network 40 may include a plurality of individual networks, such as wireless network 42 and network 44, each of which may include a plurality of devices 10.

Additionally, as those skilled in the art will appreciate, one or more LANs may be included (not shown), where a LAN may comprise a plurality of intelligent workstations or similar devices coupled to a host processor.

Still referring to FIG. 2, the networks 42 and 44 may also include mainframe computers or servers, such as a gateway computer 46 or application server 47 (which may access a data repository 48). A gateway computer 46 serves as a point of entry into each network 44. The gateway 46 may be coupled to another network 42 by means of a communications link 50a. The gateway 46 may also be directly coupled to one or more devices 10 using a communications link 50b, 50c. Further, the gateway 46 may be indirectly coupled to one or more devices 10. The gateway computer 46 may also be coupled 49 to a storage device (such as data repository 48). The gateway computer 46 may be implemented utilizing an Enterprise Systems Architecture/370™ computer available from IBM, an Enterprise Systems Architecture/390® computer, etc. Depending on the application, a midrange computer, such as an Application System/400® (also known as an AS/400®) may be employed. (“Enterprise Systems Architecture/370” is a trademark of IBM; “Enterprise Systems Architecture/390”, “Application System/400”, and “AS/400” are registered trademarks of IBM.)

Those skilled in the art will appreciate that the gateway computer 46 may be located a great geographic distance from the network 42, and similarly, the devices 10 may be located a substantial distance from the networks 42 and 44. For example, the network 42 may be located in California, while the gateway 46 may be located in Texas, and one or more of the devices 10 may be located in New York. The devices 10 may connect to the wireless network 42 using a networking protocol such as the Transmission Control Protocol/Internet Protocol (“TCP/IP”) over a number of alternative connection media, such as cellular phone, radio frequency networks, satellite networks, etc. The wireless network 42 preferably connects to the gateway 46 using a network connection 50a such as TCP or UDP (User Datagram Protocol) over IP, X.25, Frame Relay, ISDN (Integrated Services Digital Network), PSTN (Public Switched Telephone Network), etc. The devices 10 may alternatively connect directly to the gateway 46 using dial connections 50b or 50c. Further, the wireless network 42 and network 44 may connect to one or more other networks (not shown), in an analogous manner to that depicted in FIG. 2.

In preferred embodiments, the present invention is implemented in software. Software programming code which embodies the present invention is typically accessed by the microprocessor 12 (e.g. of device 10 and/or server 47) from long-term storage media 30 of some type, such as a CD-ROM drive or hard drive. The software programming code may be embodied on any of a variety of known media for use with a data processing system, such as a diskette, hard drive, or CD-ROM. The code may be distributed on such media, or may be distributed from the memory or storage of one computer system over a network of some type to other computer systems for use by such other systems. Alternatively, the programming code may be embodied in the memory 28, and accessed by the microprocessor 12 using the bus 14. The techniques and methods for embodying software programming code in memory, on physical media, and/or distributing software code via networks are well known and will not be further discussed herein.

A user of the present invention (e.g. a software installer or a software developer creating a software installation package) may connect his computer to a server using a wireline connection, or a wireless connection. (Alternatively, the present invention may be used in a stand-alone mode without having a network connection.) Wireline connections are those that use physical media such as cables and telephone lines, whereas wireless connections use media such as satellite links, radio frequency waves, and infrared waves. Many connection techniques can be used with these various media, such as: using the computer's modem to establish a connection over a telephone line; using a LAN card such as Token Ring or Ethernet; using a cellular modem to establish a wireless connection; etc. The user's computer may be any type of computer processor, including laptop, handheld or mobile computers; vehicle-mounted devices; desktop computers; mainframe computers; etc., having processing capabilities (and communication capabilities, when the device is network-connected). The remote server, similarly, can be one of any number of different types of computer which have processing and communication capabilities. These techniques are well known in the art, and the hardware devices and software which enable their use are readily available. Hereinafter, the user's computer will be referred to equivalently as a “workstation”, “device”, or “computer”, and use of any of these terms or the term “server” refers to any of the types of computing devices described above.

When implemented in software, the present invention may be implemented as one or more computer software programs. The software is preferably implemented using an object-oriented programming language, such as the Java™ programming language. The model which is used for describing the aspects of software installation packages is preferably designed using object-oriented modeling techniques of an object-oriented paradigm. In preferred embodiments, the objects which are based on this model, and which are created to describe the installation aspects of a particular installation package, may be specified using a number of approaches, including but not limited to: JavaBeans™ or objects having similar characteristics; structured markup language documents (such as XML documents); object descriptors of an object modeling notation; or Object REXX or objects in an object scripting language having similar characteristics. (“Java” and “JavaBeans” are trademarks of Sun Microsystems, Inc.) For purposes of illustration and not of limitation, the following description of preferred embodiments refers to objects which are JavaBeans.

An implementation of the present invention may be executing in a Web environment, where software installation packages are downloaded using a protocol such as the HyperText Transfer Protocol (HTTP) from a Web server to one or more target computers which are connected through the Internet. Alternatively, an implementation of the present invention may be executing in other non-Web networking environments (using the Internet, a corporate intranet or extranet, or any other network) where software packages are distributed for installation using techniques such as Remote Method Invocation (“RMI”) or Common Object Request Broker Architecture (“CORBA”). Configurations for the environment include a client/server network, as well as a multi-tier environment. Or, as stated above, the present invention may be used in a stand-alone environment, such as by an installer who wishes to install a software package from a locally-available installation media rather than across a network connection. Furthermore, it may happen that the client and server of a particular installation both reside in the same physical device, in which case a network connection is not required. (Thus, a potential target system being interrogated may be the local device on which an implementation of the present invention is implemented.) A software developer or software installer who prepares a software package for installation using the present invention may use a network-connected workstation, a stand-alone workstation, or any other similar computing device. These environments and configurations are well known in the art.

The target devices with which the present invention may be used advantageously include end-user workstations, mainframes or servers on which software is to be loaded, or any other type of device having computing or processing capabilities (including “smart” appliances in the home, cellular phones, personal digital assistants or “PDAs”, dashboard devices in vehicles, etc.).

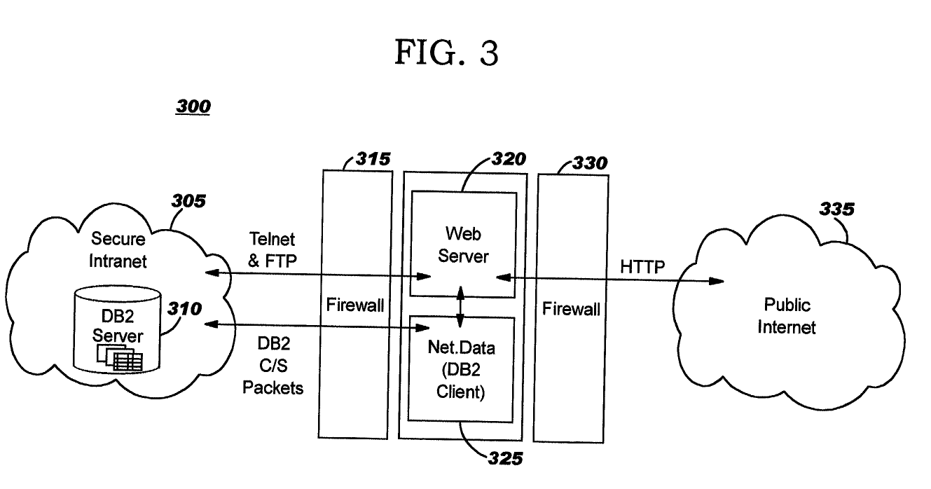

Preferred embodiments of the present invention will now be discussed in more detail with reference to FIGS. 3 through 9.

In today's networked client/server world, enterprises commonly struggle with determining optimal topologies or configurations for multiple software hosts, especially when those hosts are physically located across disparate geographies. For instance, it might be desirable to optimize the response time of an Internet Web site that needs to satisfy many client requests in a timely manner. This optimization process might involve defining a configuration that supports server load balancing, repeaters or similar server farm “appliances”, multi-processor backups, etc. These types of complex configurations are very difficult for a person such as a systems administrator to analyze when preparing for a software installation.

An additional difficulty of prior art software installation techniques is that the suitability of a target system for installation of a given software product is often determined using an arbitrary, manual process. A software installer using prior art techniques needs to understand the requirements of each particular product that is to be installed (e.g. dependencies on other software products) in order to evaluate whether that product can successfully be installed on a given computer—or, alternatively, the installer might simply attempt the install and determine the “missing pieces” through trial and error. Either approach has disadvantages that will be apparent.

A sample target environment 300 is depicted in FIG. 3, and is used to further illustrate the advantages of the present invention. Suppose that a software installer would like to perform a remote installation of a product such as the DB2® Administration Client software from IBM into this environment. (“DB2” is a registered trademark of IBM.) Further suppose that the software installer wishes to use a “push” approach whereby the software will be installed from a staging server located within the secure intranet 305. A software distribution application such as that which has been described in the related inventions may be used to perform this software installation, once the techniques of the present invention have been used to determine the target system(s). To set up the proper configuration for the remote installation in this scenario, it is necessary to:

(1) Install a product named “Net.Data” on a computer which also hosts a Web server, and ensure that this Net.Data product can access a DB2 Server product which is installed on a device inside the intranet 305. (Exemplary placement of these products is shown at 325, 320, and 310, respectively.) This further requires:

(a) installing the DB2 Administration Client product on the Web server machine (see element 320 in this example), and

(b) configuring the firewall 315 to allow DB2 traffic to pass through. (One method in which this may be done is to add a packet filtering rule to allow DB2 client requests from Net.Data, and acknowledge packets from the DB2 Server to Net.Data.)

(2) Allow FTP and Telnet access between the Web server 320 and the secure intranet 305. One method for enabling this access is to install a Socks server on the Web server machine.

(3) Specify, in the packet filtering configuration of the software for firewall 330, that (a) incoming TCP packets from the standard HTTP port can access the Web server 320, and (b) outgoing TCP acknowledge packets from the Web server can go to any hosts on the public Internet 335.

While only a single DB2 Server, Web Server, and Net.Data/DB2 Administration Client are shown as being installed in FIG. 3, in an actual network there may be a large number of potential devices on which these products might reside.

To set up a configuration properly requires, inter alia, that each of the target machines is properly suited for the software which is to be installed there. For the example scenario described above, it must be possible to configure a device to support a Web server, Net.Data, a Socks server, and DB2 Administration Client. If a candidate device does not have sufficient storage space available for these products, then that device cannot fulfill the necessary role. On the other hand, if multiple candidate devices have sufficient space, and one of these devices already has a Web server installed, and/or already has Net.Data or a Socks server installed, then selecting that device over other devices which do not have these products installed will typically simplify and shorten the installation process. When using prior art techniques, the software installer has to manually determine the list of requirements for installing each software product, and then manually determine how well-suited each potential target system is for these requirements. This is a complex, time-consuming task.

The present invention provides tailored, product-specific techniques for evaluating information about various devices in a network. Using the disclosed techniques, an information technology professional with little or no product-specific knowledge can perform an efficient, successful product installation. Product-specific requirements are programmatically evaluated, using a generic approach that is easily adaptable to a wide variety of software products.

The techniques of the present invention enable programmatically determining the suitability of various candidate target systems, where this suitability may encompass a number of factors. (While preferred embodiments are described with reference to software criteria, this is for purposes of illustration and not of limitation. Hardware and/or firmware criteria may also be evaluated using the techniques of the present invention.) With reference to the scenario of FIG. 3, an installation tool which incorporates the teachings of the present invention may operate as follows:

(1) Poll the intranet 305 to find the computer(s) which are located between two firewalls (such as firewall 315 and firewall 330).

(2) Determine which of these computers are configured as a Web server, have Net.Data already installed, and/or have a Socks server installed.

(3) Determine whether product-specific storage space requirements can be met by these computers.

(4) Determine which of these computers have product-specific prerequisite software (such as the Kom shell “pdksh rpm” package, for example) available.

(5) Query the firewall configuration to determine whether any existing firewalls support the appropriate incoming and outgoing TCP packet permissions.

(For installation of other software products, the product-specific requirements are substituted into an analogous procedure.)

The network information and product-specific information can then be used to provide a suitability assessment for each potential target computer on the network, according to the techniques disclosed herein. It is likely that no target computer will be found that meets all the requirements, and therefore preferred embodiments rank the suitability of each potential target and provide an in-order list that may be used to recommend target systems to the software installer. (Note that preferred embodiments assume that the software installer is a person, such as a systems administrator. Alternatively, the software installer may be a programmatic process, in which case the ranked list may be specified as input to this programmatic process. In this latter case, the ranking is supplied in a machine-readable form.) This list of recommended target systems can then be used by the software installer to determine how the installation process should progress. (For example, if a target system is found which includes Net.Data, then installing the DB2 Administration Client can proceed without installing Net.Data; conversely, it may be necessary to include Net.Data in the software installation package.)

Preferred embodiments of the present invention analyze potential target systems using one or more product-specific criteria (which are preferably specified by an install package developer), along with product-specific weights which are given to those criteria. As one example, minimum disk space requirements will be heavily weighted in most (and possibly all) cases, because an installation is not possible if storage space requirements are not met. On the other hand, a requirement such as the TCP permissions discussed above might be given a relatively low weight, because this is something that can be adjusted after the DB2 Administration Client is installed. As another example, processor speed of the potential target system might be given a heavy weight when installing a time-sensitive software product.

Security considerations may also be addressed using the techniques of the present invention. For example, the sample environment 300 in FIG. 3 is a high-security environment, having 2 firewalls 315 and 330. An alternative set of criteria and weights might be developed for installing this same DB2 Administrative Client if an intermediate security level is acceptable, and still another set might be developed for a low security environment.

The disclosed techniques greatly reduce the burden on the software installer for performing a remote software installation. Responsibility for specifying the requirements or criteria for installing a given software product, and for properly weighting these criteria, is preferably assigned to an information technology professional such as a product developer or install package developer. (The term “install package developer” is used herein for ease of reference, and is intended to include any such professionals.) The install package developer is typically well-acquainted with the requirements of a particular product, and thus can reasonably be expected to develop the set of criteria and weightings that will be used in the suitability assessment disclosed herein.

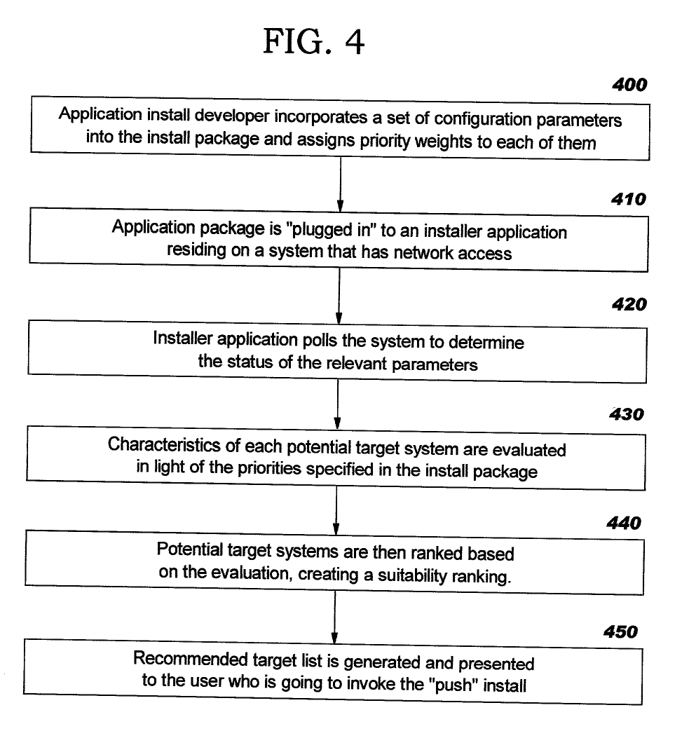

The flowchart in FIG. 4 provides logic which may be used to implement preferred embodiments of the present invention, as will now be described. The developer of the install package for a particular software application defines a set of criteria, referred to in FIG. 4 as configuration parameters, and in preferred embodiments, incorporates these criteria into the install package (Block 400). Priority weights are also assigned to each of these criteria. (In alternative embodiments, rather than incorporating the criteria and weights into the install package, the criteria/weights may be separately stored, and an association with the install package may be defined.)

Preferably, the weights are associated with specific values of the criteria. For example, if the criteria pertains to whether Net.Data is installed, then a weight may be associated with a positive status for that criteria. For a particular criteria, more than one weight might be assigned to various values of the criteria. For example, if the criteria pertains to the amount of storage space available for installing products on a potential target system, then increasingly-higher weights might be assigned to larger available-space values.

Note that the parameters for which criteria and weights are specified may pertain to installation-time information, such as the minimum storage space required to install the product, and/or to run-time information, such as whether a protocol suite to be used by the product has been installed or how fast the processor of the target device operates. The terms “configuration parameters”, “installation information”, and “installation parameters” are used synonymously herein, and are intended to refer to these various types of information.

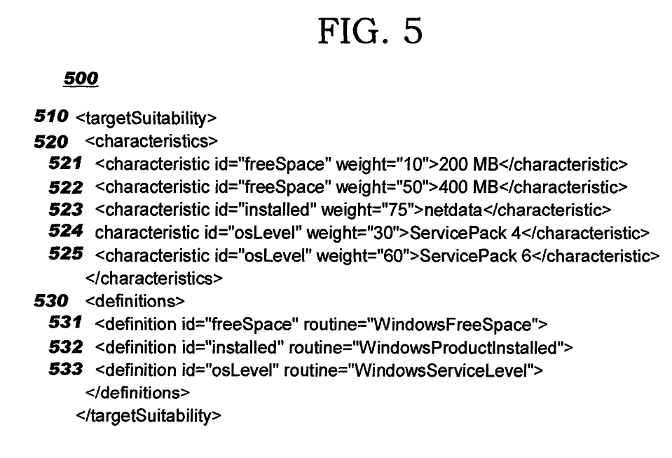

Referring briefly to FIG. 5, a sample structured markup language document fragment 500 is depicted. (In the example, XML is used as the markup language.) This fragment 500 shows one way in which the configuration parameters and weights to be used by an implementation of the present invention may be specified. As shown therein, a “<targetSuitability>” element 510 contains a set of characteristics 520 and a set of definitions 530. The characteristics comprise one or more product-specific factors or criteria and the weights associated with various values for those criteria. For example, the combination of characteristics 521 and 522 indicates that, for the product represented by document fragment 500, free storage space of 200 megabytes is assigned a weight of 10, while free storage space of 400 megabytes is assigned a weight of 50. Thus, in this example, the heavier weight of characteristic 522 indicates that a target system having 400 megabytes of storage available is heavily favored over a target system having only 200 megabytes available. Characteristic 523 indicates that a weight of 75 is assigned if the installed products on a potential target computer include Net.Data. Thus, a target device with Net.Data already installed will be heavily favored over other devices. And finally, the combination of characteristics 524 and 525 indicates that “ServicePack 6” is rather heavily favored over “ServicePack 4” for the level of the operating system.

In this example 500, the attribute “freeSpace” is used to denote a characteristic pertaining to available storage space, “installed” denotes the installed products of a potential target, and “osLevel” denotes the existing operating system level of that target. No particular naming convention is required for these attribute values: the “<definitions>” element specifies a mapping between the names given to attributes in a particular implementation and the routines that will evaluate an appropriate factor, as will now be described.

The “<definitions>” element includes a child element corresponding to each of the attributes specified in the “<characteristic>” elements. (See element 530 and elements 521-525 in the example.) According to preferred embodiments, each “<definition>” element includes an attribute (named “id” in the example) which specifies a characteristic name and an attribute (named “routine” in the example) which specifies the name of a software routine. When invoked, this software routine will return an appropriate value for use in the weighting computation.

Thus, to evaluate the free space of a potential target system, a “WindowsFreeSpace” routine may be invoked. (See element 531.) The result of this invocation determines whether a weight of 10 or a weight of 50 will be given to the target system. (See elements 521 and 522.) To determine what products are installed on the target, a “WindowsProductlnstalled” routine may be invoked, and a “WindowsServiceLevel” routine may be used to determine the service pack level of the operating system. (See elements 532 and 533, respectively.)

While the sample document fragment 500 indicates that the <characteristics> element and <definitions> element are sibling elements in a single document, alternatives include specifing these elements within distinct parents and using separate documents.

Preferred embodiments of the present invention assume that an installation agent or analogous software routine is resident on the remote target system, and is adapted to carrying out the routines which are named in the “routine” attributes of the <definition> elements of the markup language document, as exemplified by document fragment 500. This is further discussed below, with reference to Block 420 of FIG. 4.

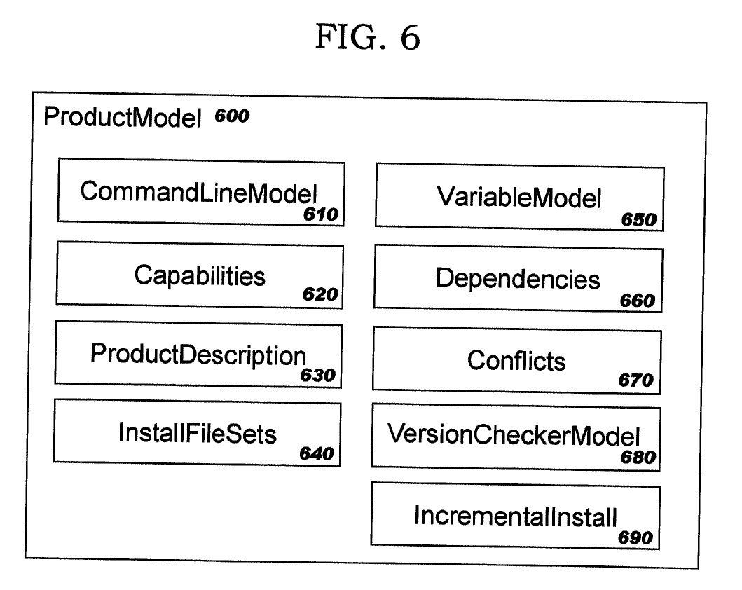

Returning now to the discussion of FIG. 4, at Block 410, the application to be installed is preferably plugged in to a software installation application that resides on a server that has network access. This server is also referred to herein as a “staging server”, and according to preferred embodiments, performs software installation using a “push” installation approach. “Push” installation refers to an approach whereby software is configured for installation at the staging server, and is then distributed from that staging server over a network to one or more target computers for remote installation on those target computers. In a push installation model, a user typically interacts with a graphical user interface (“GUI”) display at the local staging server to provide a number of configuration values and to otherwise direct the distribution and remote installation operation. An installer application which may be used in Block 410 is defined by the related inventions, and will be discussed below with reference to FIGS. 6-9.

The installer application then determines which configuration parameters are to be used in the suitability assessment for this software product (Block 420), and polls the potential target computers to determine the status of those parameters. Referring again to the example 500 in FIG. 5, in preferred embodiments the configuration parameters are determined by parsing the <targetSuitability> element to locate the set of attributes identified in the <characteristic> elements. Polling the potential targets comprises locating the <definition> elements which correspond to each of the attributes in this set, and then extracting the values of each “routine” attribute specified therein. A message is then formatted for transmission to the potential target computers, where that message identifies the routines which are to be invoked. As discussed above, an installation agent or similar software resident on the potential targets receives this message, and carries out the invocations it specifies. A response message is created, providing values for each of the routines which have been invoked, and is transmitted back to the staging server.

The messages exchanged between the staging server and potential target systems are preferably encoded in a structured markup language, such as XML or a derivative thereof, and may be defined according to a schema or Document Type Definition (“DTD”). Details of schema definitions and DTDs are well known to those of skill in the art, and will not be described in detail herein. A protocol such as Java RMI or CORBA is preferably used for transmitting these messages.

Note that Block 420 assumes that all potential target computers are polled. Alternatively, a selective polling process may be used. For example, a GUI display showing all potential target computers in the network may be presented, and the software installer may be allowed to choose from among those targets. The manner in which the targets to be polled are determined does not form part of the inventive techniques of the present invention. References herein to potential targets are intended to include a subset which is selectively determined.

Block 430 evaluates the characteristics of each potential target system in light of the values in the response message for that target, applying the weights which have been specified in the corresponding <characteristic> elements. The weighted values are then summed, creating a suitability assessment value, and these suitability assessment values are then sorted into a ranked list (Block 440). This list is augmented with (or otherwise associated with) an identification of the target system represented by each assessment value, and the resulting list is provided (Block 450) to the software installer (e.g. by presenting a display to the user who will invoke the push installation). This list can then be used in selecting the actual target(s) of the installation.

In this manner, the software installer is relieved from the burden of determining which factors are relevant for a particular product to be installed, and which of those factors are the most important, as well as separately (and manually) determining which computers satisfy the requirements for each factor and to what degree those requirements are met.

Preferably, creation of the installation image is not carried out until the ranked suitability list has been provided to the software installer, after which the installation image can be configured accordingly.

In an optional enhancement of the present invention, the logic depicted in FIG. 4 may be adapted for analyzing potential target computers based on the requirements of more than one software product. This enhancement preferably comprises repeating operation of Blocks 400-430 to determine the weighted values for each potential target (although a combined message requesting invocation of corresponding routines on the target systems is preferably transmitted, and a combined response message is preferably returned therefrom). The summed values in this enhancement represent the suitability of the potential target in terms of the set of software products for which requirements are being analyzed. In this enhancement, Block 440 creates a ranked list in terms of this set of software products, and Block 450 provides this list to the installer.

Preferred embodiments of the present invention may leverage an object model for software package installation, in which a framework is defined for creating one or more objects which comprise each software installation package. Preferred embodiments of the software object model and framework are described in the related inventions. (In alternative embodiments, the techniques disclosed herein may be used with software installation packages adhering to models/frameworks other than those of the related inventions.)

As disclosed in the related inventions, each installation object preferably comprises object attributes and methods for the following:

1) A manifest, or list, of the files comprising the software package to be installed.

2) Information on how to access the files comprising the software package. This may involve:

a) explicit encapsulation of the files within the object, or

b) links that direct the installation process to the location of the files (which may optionally include a specification of any required access protocol, and of any compression or unwrapping techniques which must be used to access the files).

3) Default response values to be used as input for automatically responding to queries during customized installs, where the default values are preferably specified in a response file. The response file may specify information such as how the software package is to be subset when it is installed, where on the target computer it is to be installed, and other values to customize the of the installation process.

4) Methods, usable by a systems administrator or other software installation personnel, for setting various response values or for altering various ones of the default response values to tailor a customized install.

5) Validation methods to ensure the correctness and internal consistency of a customization and/or of the response values otherwise provided during an installation. (Note, however, that the validation techniques disclosed in the related inventions pertain to local validation of installation data, whereas the present invention discloses techniques for remote validation. The related invention titled “Efficient Installation of Software Packages”, referred to hereinafter as “the conditional installation invention”, further discloses that validation code may be included in an installation package to control an incremental conditional installation process. Distinctions between these related inventions and the present invention will be discussed in more detail below.)

6) Optionally, localizable strings (i.e. textual string values that may be translated, if desired, in order to present information to the installer in his preferred natural language).

7) Instructions (referred to herein as the “command line model”) on how the installation program is to be invoked, and preferably, how return code information or other information related to the success or failure of the installation process may be obtained.

8) The capabilities of the software package (e.g. the functions it provides).

9) A specification of the dependencies, including prerequisite or co-requisites, of the software package (such as the required operating system, including a particular level thereof; other software functions that must be present if this package is to be installed; software functions that cannot be present if this package is installed; etc.).

The conditional installation invention discloses using the install entity as described by the related inventions, and conditionally distributing and executing the installation image based on outcome of an incremental routine of the install package which is executed before downloading and executing the subsequent dependent routines of the total install package. As an example, in the case of a remote installation, the conditional installation invention discloses that a small prerequisite routine may be dispatched over a network connection from the total install package (rather than sending the entire install package). This dispatched routine may then be executed on the remote machine, and based on its outcome, a return code may be transmitted from the remote machine to indicate whether subsequent routines from the install package should be retrieved and executed. However, this conditional installation invention does not disclose weighting installation information nor using weighted values to provide a suitability assessment as disclosed herein.

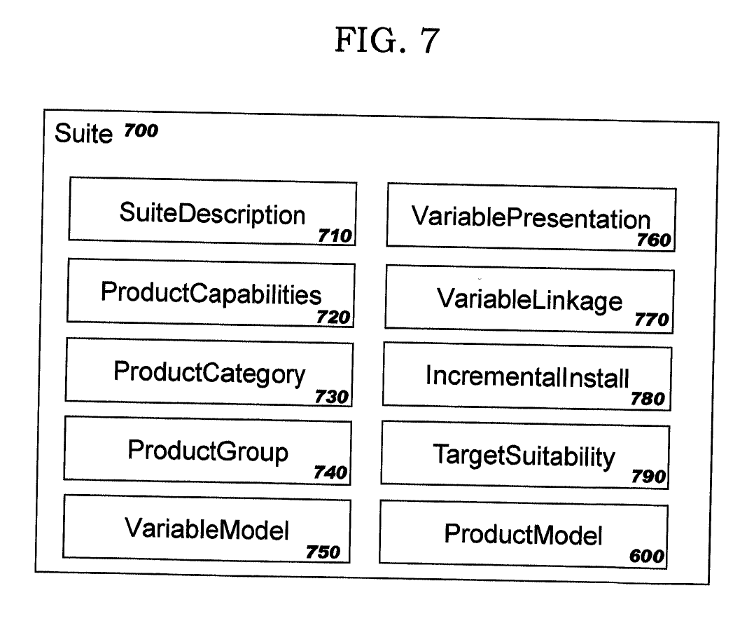

A preferred embodiment of the object model used for defining installation packages as disclosed in the related inventions is depicted in FIGS. 6 and 7. FIG. 6 illustrates a preferred object model to be used for describing each software component present in an installation package. A graphical containment relationship is illustrated, in which (for example) ProductModel 600 is preferably a parent of one or more instances of CommandLineModel 610, Capabilities 620, etc. FIG. 7 illustrates a preferred object model that may be used for describing a suite comprising all the components present in a particular installation package. (It should be noted, however, that the model depicted in FIGS. 6 and 7 is merely illustrative of one structure that may be used to represent installation packages according to the present invention. Other subclasses may be used alternatively, and the hierarchical relationships among the subclasses may be altered, without deviating from the inventive concepts disclosed herein.) A version of the object model depicted by FIGS. 6 and 7 has been described in detail in the related inventions. This description is presented here as well in order to establish a context for the present invention. The manner in which this object model that may be used for supporting the present invention is also described herein in context of the overall model.

Note that each of the related inventions may differ slightly in the terms used to describe the object model and the manner in which it is processed. For example, the related invention pertaining to use of structured documents refers to elements and subelements, and storing information in document form, whereas the related invention pertaining to use of JavaBeans refers to classes and subclasses, and storing information in resource bundles. As another example, the related inventions disclose several alternative techniques for specifying information for installation objects, including: use of resource bundles when using JavaBeans; use of structured documents encoded in a notation such as the Managed Object Format (“MOF”) or XML; and use of properties sheets. These differences will be well understood by one of skill in the art. For ease of reference when describing the present invention, the discussion herein is aligned with the terminology used in the JavaBeans-based disclosure; it will be obvious to those of skill in the art how this description may be adapted in terms of the other related inventions.

A ProductModel 600 object class is defined, according to the related inventions, which serves as a container for all information relevant to the installation of a particular software product (i.e. component). The contained information is shown generally at 610 through 680, and comprises the information for a particular component installation, as will now be described in more detail. CommandLineModel class 610 is used for specifying information about how to invoke an installation (i.e. the “command line” information, which includes the command name and any arguments). In preferred embodiments of the object model disclosed in the related inventions, CommandLineModel is an abstract class, and has subclasses for particular types of installation environments. These subclasses preferably understand, inter alia, how to install certain installation utilities or tools. For example, if an installation tool “ABC” is to be supported for a particular installation package, an ABCCommandLine subclass may be defined. Instances of this class then provide information specific to the needs of the ABC tool. A variety of installation tools may be supported for each installation package by defining and populating multiple such classes. Preferably, instances of these classes reference a resource or resource bundle which specifies the syntax of the command line invocation. (Alternatively, the information may be stored directly in the instance.)

Instances of the CommandLineModel class 610 preferably also specify the response file information (or a reference thereto), enabling automated access to default response values during the installation process. In addition, these instances preferably specify how to obtain information about the success or failure of an installation process. This information may comprise identification of particular success and/or failure return codes, or the location (e.g. name and path) of a log file where messages are logged during an installation. In the latter case, one or more textual strings or other values which are designed to be written into the log file to signify whether the installation succeeded or failed are preferably specified as well. These string or other values can then be compared to the actual log file contents to determine whether a successful installation has occurred. For example, when an installation package is designed to install a number of software components in succession, it may be necessary to terminate the installation if a failure is encountered for any particular component. The installation engine of the present invention may therefore automatically determine whether each component successfully installed before proceeding to the next component.

Additional information may be specified in instances of CommandLineModel, such as timer-related information to be used for monitoring the installation process. In particular, a timeout value may be deemed useful for determining when the installation process should be considered as having timed out, and should therefore be terminated. One or more timer values may also be specified that will be used to determine such things as when to check log files for success or failure of particular interim steps in the installation.

Instances of a Capabilities class 620 are used to specify the capabilities or functions a software component provides. Capabilities thus defined may be used to help an installer select among components provided in an installation package, and/or may be used to programmatically enforce install-time checking of variable dependencies. As an example of the former, suppose an installation package includes a number of printer driver software modules. The installer may be prompted to choose one of these printer drivers at installation time, where the capabilities can be interrogated to provide meaningful information to display to the installer on a selection panel. As an example of the latter, suppose Product A is being installed, and that Product A requires installation of Function X. The installation package may contain software for Product B and Product C, each of which provides Function X. Capabilities are preferably used to specify the functions provided by Product B and Product C (and Dependencies class 660, discussed below, is preferably used to specify the functions required by Product A). The installation engine can then use this information to ensure that either Product B or Product C will be installed along with Product A.

As disclosed in the related inventions, ProductDescription class 630 is preferably designed as a container for various types of product information. Examples of this product information include the software vendor, application name, and software version of the software component.

Instances of this class are preferably operating-system specific. The locations of icons, sound and video files, and other media files to be used by the product (during the installation process, and/or at run-time) may be specified in instances of ProductDescription. For licensed software, instances of this class may include licensing information such as the licensing terms and the procedures to be followed for registering the license holder. When an installation package provides support for multiple natural languages, instances of ProductDescription may be used to externalize the translatable product content (that is, the translatable information used during the installation and/or at run-time). This information is preferably stored in a resource bundle (or other type of external file or document, referred to herein as a resource bundle for ease of reference) rather than in an object instance, and will be read from the resource bundle on an on-demand basis.

The InstallFileSets class 640 is used in preferred embodiments of the object model disclosed in the related inventions as a container for information that relates to the media image of a software component. Instances of this class are preferably used to specify the manifest for a particular component. Tens or even hundreds of file names may be included in the manifest for installation of a complex software component. Resource bundles are preferably used, rather than storing the information directly in the object instance.

The related inventions disclose use of the VariableModel class 650 as a container for attributes of variables used by the component being installed. For example, if a user identifier or password must be provided during the installation process, the syntactical requirements of that information (such as a default value, if appropriate; a minimum and maximum length; a specification of invalid characters or character strings; etc.) may be defined for the installation engine using an instance of VariableModel class. In addition, custom or product-specific validation methods may be used to perform more detailed syntactical and semantic checks on values that are supplied (for example, by the installer) during the installation process. (Note that these validation methods, being part of the Product Model 600, form part of the install image itself and are designed for use during the installation process.) As disclosed for an embodiment of the related inventions, this validation support may be provided by defining a CustomValidator abstract class as a subclass of VariableModel, where CustomValidator then has subclasses for particular types of installation variables. Examples of subclasses that may be useful include StringVariableModel, for use with strings; BooleanVariableModel, for use with Boolean input values; PasswordVariableModel, for handling particular password entry requirements; and so forth. Preferably, instances of these classes use a resource bundle that specifies the information (including labels, tooltip information, etc.) to be used on the user interface panel with which the installer will enter a value or values for the variable information.

Dependencies class 660 is used to specify prerequisites and co-requisites for the installation package, as disclosed in the related inventions. Information specified as instances of this class, along with instances of the Capabilities class 620, is used at install time to ensure that the proper software components or functions are available when the installation completes successfully. (Note that these classes are defined by the related inventions for specifying software that needs to be installed if it is not already installed on the target system, and therefore these are specific to the solution being installed. The present invention, on the other, hand, might or might not refer to these types of required, or prerequisite, software components when evaluating what is installed on potential target machines to perform a suitability analysis. That is, if a required/prerequisite component is specified for suitability analysis purposes, then a greater preference will be indicated for target systems that already have that component installed. However, the suitability analysis is not limited to checking for components that have been identified as required/prerequisite components, and thus according to preferred embodiments there is no need to link the criteria used in the suitability analysis and instances of either the Dependencies class or the Capabilities class,)

The related inventions disclose providing a Conflicts class 670 as a mechanism to prevent conflicting software components from being installed on a target device. For example, an instance of Conflicts class for Product A may specify that Product Q conflicts with Product A. Thus, if Product A is being installed, the installation engine will determine whether Product Q is installed (or is selected to be installed), and generate an error if so.

VersionCheckerModel class 680 is provided to enable checking whether the versions of software components are proper, as disclosed in the related inventions. For example, a software component to be installed may require a particular version of another component.

The conditional installation invention defines an additional class, Incrementalinstall 690. As disclosed in this conditional installation invention, incrementalinstall 690 is a subclass of ProductModel 600 and may be used to provide a conditional distribution and installation of the corresponding software component. (Alternatively, this information may be represented within one or more of the previously-defined classes.)

Because the conditional installation invention is distinct from the present invention, it will not be described in detail herein. Refer to the conditional installation patent for more information.

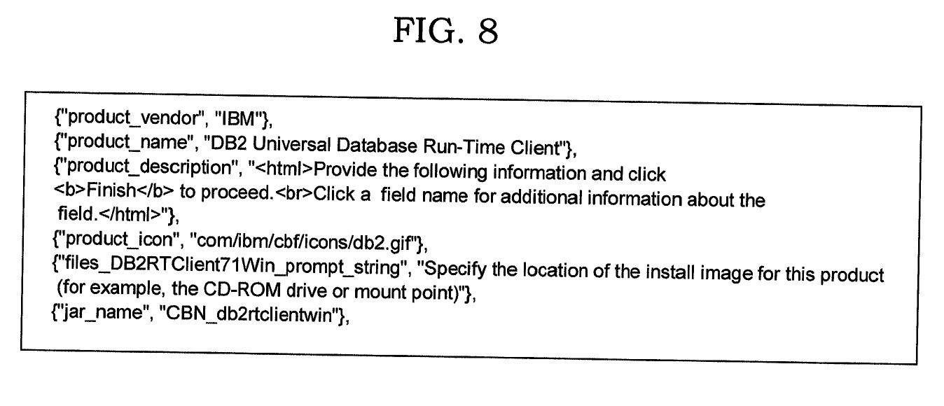

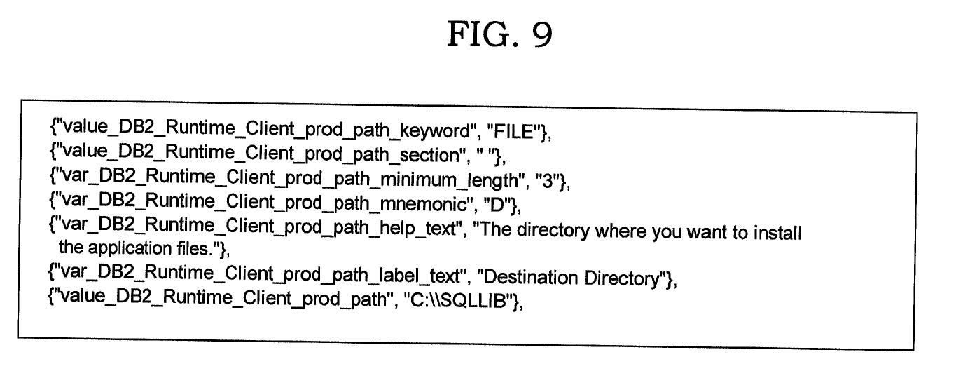

Preferably, the resource bundles referenced by the software components of the present invention are structured as product resource bundles and variable resource bundles. Examples of the information that may be specified in product resource bundles (comprising values to be used by instances of CommandLineModel 610, etc.) and in variable resource bundles (with values to be used by instances of VariableModel 650, ProductDescription 630, etc.) are depicted in FIGS. 8 and 9, respectively. (Note that while 2 resource bundles are shown for the preferred embodiment, this is for purposes of illustration only. The information in the bundles may be organized in many different ways, including use of a separate bundle for each class. When information contained in the bundles is to be translated into multiple natural languages, however, it may be preferable to limit the number of such bundles.)

Referring now to FIG. 7, an object model as disclosed in the related inventions for representing an installation suite comprising all the components present in a particular installation package will now be described. A Suite 700 object class serves as a container of containers, with each instance containing a number of suite-level specifications in subclasses shown generally at 710 through 770. Each suite object also contains one or more instances of ProductModel 600 class, one instance for each software component in the suite. The Suite class may be used to enforce consistency among software components (by handling the inter-component prerequisites and co-requisites), and to enable sharing of configuration variables among components. (Furthermore, as disclosed in the conditional installation invention, the Suite class 700 may contain suite-level information to be used in a conditional installation, as described therein.)

SuiteDescription class 710 is defined in the related inventions as a descriptive object which may be used as a key when multiple suites are available for installation. Instances of SuiteDescription preferably contain all of the information about a suite that will be made available to the installer. These instances may also provide features to customize the user interface, such as build boards, sound files, and splash screens.

disclosed in the related inventions, ProductCapabilities class 720 provides similar information as Capabilities class 620, and may be used to indicate required or provided capabilities of the installation suite.

ProductCategory class 730 is defined in the related inventions for organizing software components (e.g. by function, by marketing sector, etc.). Instances of ProductCategory are preferably descriptive, rather than functional, and are used to organize the display of information to an installer in a meaningful way. A component may belong to multiple categories at once (in the same or different installation suites).

As disclosed in the related inventions, instances of ProductGroup class 740 are preferably used to bundle software components together for installation. Like an instance of ProductCategory 730, an instance of ProductGroup groups products; unlike an instance of ProductCategory, it then forces the selection (that is, the retrieval and assembly from the directory) of all software components at installation time when one of the components in the group (or an icon representing the group) is selected. The components in a group are selected when the suite is defined, to ensure their consistency as an installation group.

Instances of VariableModel class 750 provide similar information as VariableModel class 650, as discussed in the related inventions, and may be used to specific attributes of variables which pertain to the installation suite.

VariablePresentation class 760 is used, according to the related inventions, to control the user interface displayed to the installer when configuring or customizing an installation package. One instance of this class is preferably associated with each instance of VariableModel class 750. The rules in the VariableModel instance are used to validate the input responses, and these validated responses are then transmitted to each of the listening instances of VariableLinkage class 770.

As disclosed in the related inventions, instances of VariableLinkage class 770 hold values used by instances of VariableModel class 750, thereby enabling sharing of data values. VariableLinkage instances also preferably know how to translate information from a particular VariableModel such that it meets the requirements of a particular ProductModel 600 instance.

The conditional installation invention defines an Incrementallnstall class 780 that may be provided for use in a conditional installation that pertains to the entire suite. (Suite-level conditional installation information may alternatively be represented in one or more of the existing classes.) If an implementation of the conditional installation invention chooses not to support conditional installation at the suite level, then this class 780 is omitted. The suite-level Incrementallnstall class 780 is similar to the component-level Incrementallnstall class 690 which was previously described. As an example of suite-level checking, code may be performed to detect the type of target device and to suppress distribution and installation of large installation images in certain cases, based upon that information (e.g. for constrained devices such as PDAs or devices that connect to a network using a relatively expensive wireless connection).

TargetSuitability class 790 is used by preferred embodiments to store instances of the criteria and weights to be used in performing a suitability analysis, according to the present invention. Thus, a markup document such as sample fragment 500 of FIG. 5 might be stored as an instance of TargetSuitability class. (Alternatively, the criteria and weights might be stored elsewhere, such as in a markup document which is associated with the install image but which includes other types of information beyond the criteria and weights.)

Each instance of ProductModel class 600 in a suite is preferably independently serializable, as discussed in the related inventions, and is merged with other such assembled or retrieved instances comprising an instance of Suite 700.

During the customization process, an installer may select a number of physical devices or machines on which software is to be installed from a particular installation package. Furthermore, he may select to install individual ones of the software components provided in the package. This is facilitated by defining a high-level object class (not shown in FIGS. 6 or 7) which is referred to herein as “Groups”, which is a container for one or more Group objects. An implementation of the present invention may be used to assist the software installer in selecting target systems on which the installation package (or selected components thereof) is to be installed, as discussed above. A Group object may contain a number of Machine objects and a number of ProductModel objects (where the ProductModel objects describe the software to be installed on those machines, according to the description of FIGS. 6 and 7). Machine objects preferably contain information for each physical machine on which the software is to be installed, such as the machine's Internet Protocol (IP) address and optionally information (such as text for an icon label) that may be used to identify this machine on a user interface panel when displaying the installation package information to the installer.

When using JavaBeans of the Java programming language to implement installation objects according to the installation object model, the object attributes and methods to be used for installing a software package are preferably specified as properties and methods of the JavaBeans. A JavaBean is preferably created for each software component to be included in a particular software installation package, as well as another JavaBean for the overall installation suite. When using Object REXX, the object attributes and methods to be used for installing a software package are preferably specified as properties and methods in Object REXX. When using structured documents, the object attributes and methods are preferably specified as elements in the structured documents. (Refer to the related inventions for a detailed discussion of these approaches.)

The related inventions have disclosed a general software installation process using the model and framework of their respective FIGS. 6 and 7, and preferred embodiments of logic which may be used to implement this installation process have been described therein with reference to their respective FIGS. 7 through 10. Refer to those related inventions for a description of processing that occurs to distribute and install an installation package.

As has been demonstrated, the present invention defines techniques for programmatically generating ranked list of suitable target systems for a particular product-specific software installation, using a generic approach that is easily adaptable to a wide variety of software products. Preferred embodiments leverage an object model and framework that provide a standard, consistent approach to software installation across many variable factors such as product and vendor boundaries, computing environment platforms, and the language of the underlying code as well as the preferred natural language of the installer, as was disclosed in the related inventions. An implementation of the present invention may include the teachings of one or more of these related inventions. In alternative embodiments, the techniques disclosed herein may be used to programmatically generating a ranked list of suitable target systems when building an installation image according to a model other than that disclosed in the related inventions. Use of the techniques disclosed herein provides for efficient, successful product installation by an information technology professional with little or no product-specific knowledge.

Existing software installation products may perform some level of checking of potential targets before initiating an installation. For example, an “Update Connector™ Manager” tool from IBM allows a developer to write a piece of pre-install code that does checking, and returns a code that either gives the actual install a green or a red light. (“Update Connector” is a trademark of IBM.) However, this tool does not provide for comparing among or between computers on a network to recommend topologies for complicated installations, as has been disclosed herein, and no other products providing this function are known to the inventors.

The related invention titled “Run-Time Rule-Based Topological Installation Suite” discusses obtaining information about the target environment, and using that information as input to a rules engine. However, in that invention, the target environment has already been selected when the invention operates, such that information about the environment is used to select an already-built suite configuration from among several suite configurations. The software installer is not required to select the products to be installed, by virtue of their being included in the selected suite configuration. (For example, this related invention describes how a client-specific suite configuration might be chosen instead of a server-specific configuration, based on characteristics of the target device.) The present invention, on the other hand, is directed toward analyzing potential target systems in terms of an identified software product to be installed, and making a recommendation to the software installer using programmatically-computed rankings. These rankings may then be used as an aid in selecting the target system(s) for installing that software product.

The related invention titled “Extending Installation Suites to Include Topology of Suite's Run-Time Environment” discloses use of Topologies objects within a suite to support topology-specific suite configurations. This related invention also assumes that the target environment has already been selected, and pertains to how the topology information is used when defining several different configurations for a particular suite of software products.

Neither of these related inventions is directed toward weighting of installation information, nor programmatically selecting a target for installing a particular software product. Instead, these two related inventions may be seen as a reverse approach to the present invention: whereas the related inventions are “suite centric” (that is, topology information resides in the Suite object, and is used to associate a predefined set of products with a predefined topology), the present invention is “product centric” (pertaining to individual products within a suite, and selecting targets or topologies in view of the requirements of the products).

While preferred embodiments of the present invention have been described, additional variations and modifications in that embodiment may occur to those skilled in the art once they learn of the basic inventive concepts. Therefore, it is intended that the appended claims shall be construed to include preferred embodiments as well as all such variations and modifications as fall within the spirit and scope of the invention.

What is claimed is:

1. A method of improving installation of software packages, comprising steps of:
assigning a weight to each of one or more selected values of one or more installation parameters associated with a software product installation;
determining a plurality of potential target systems on which the software product installation might be performed;
identifying a routine to analyze each of the installation parameters;
programmatically interrogating each of the potential target systems for its status of each of the installation parameters, using the identified routines; and
using the assigned weights, in combination with the selected values and the status of each of the installation parameters, to compute a suitability assessment for each of the potential target systems.

2. The method according to claim 1, wherein the programmatically interrogating step further comprises the step of invoking the identified routines at each of the potential target systems.

3. The method according to claim 1, wherein the using step further comprises the steps of:
comparing the status of each of the installation parameters to the selected values to determine the associated weight to be used for this installation parameter for this potential target system; and
adding the determined weights to yield the computed suitability assessment for this potential target system.

4. The method according to claim 1, further comprising the step of ranking the potential target systems according to their suitability assessments.

5. The method according to claim 4, further comprising the step of providing the ranking to a software installer.

6. The method according to claim 5, wherein the software installer is a person and wherein the providing step comprises the step of displaying the ranking on a graphical user interface.

7. The method according to claim 5, wherein the software installer is a programmatic process and wherein the providing step further comprises the step of supplying the ranking to the programmatic process in a machine-readable form.

8. The method according to claim 1, wherein the assigned weights and selected values are specified using a structured markup language.

9. The method according to claim 8, wherein the structured markup language is Extensible Markup Language (“XML”) or a derivative thereof.

10. The method according to claim 1, wherein the assigned weights, the selected values, and the identifications of the routines are specified using a structured markup language.

11. The method according to claim 19, wherein the specifications are part of an installation object defined for the software product installation.

12. The method according to claim 1, wherein the interrogating step further comprising the step of transmitting a message to each of the potential target systems, wherein the message specifies the identified routines.

13. The method according to claim 12, wherein the message is to be processed by an installation agent residing on each of the potential target systems.

14. The method according to claim 12, further comprising the steps of:
receiving the transmitted message at a particular one of the potential target systems;
invoking the identified routines from the received message, thereby determining the status of each of the installation parameters for this particular potential target system; and
returning the status of each of the installation parameters in a response message.

15. The method according to claim 5, further comprising the step of using the provided ranking, by the software installer, to select one or more of the potential target systems as one or more actual target systems for the software product installation.

16. The method according to claim 15, further comprising the steps of:
distributing a software installation package for the software product installation to each of the selected actual target systems; and
performing the software product installation on the selected actual target systems.

17. The method according to claim 12, wherein the specified routines in the transmitted message are encoded using a structured markup language.

18. The method according to claim 14, wherein the status of each of the installation parameters in the response message is encoded using a structured markup language.

19. The method according to claim 16, further comprising the step of configuring the software installation package prior to operation of the distributing step.

20. The method according to claim 19, wherein the configuring step further comprises reflecting the status for at least one of the installation parameters in the configured software installation package.

21. A system for improving installation of software packages, comprising:
means for determining a plurality of potential target systems on which the software product installation might be performed;
means for programmatically interrogating each of the potential target systems for its status of each of one or more installation parameters associated with a software product installation, by invoking, at each of the potential target systems, a routine which is identified for analyzing that installation parameter; and
means for using weights which are assigned to each of one or more selected values of the one or more installation parameters, in combination with the selected values and the status of each of the installation parameters, to compute a suitability assessment for each of the potential target systems.

22. The system according to claim 21, further comprising means for ranking the potential target systems according to their suitability assessments.

23. The system according to claim 22, further comprising means for providing the ranking to a software installer.

24. A computer program product for improving installation of software packages, the computer program product embodied on one or more computer-readable media and comprising:
computer-readable program code means for determining a plurality of potential target systems on which the software product installation might be performed;
computer-readable program code means for programmatically interrogating each of the potential target systems for its status of each of one or more installation parameters associated with a software product installation, by invoking, at each of the potential target systems, a routine which is identified for analyzing that installation parameter; and
computer-readable program code means for using weights which are assigned to each of one or more selected values of the one or more installation parameters, in combination with the selected values and the status of each of the installation parameters, to compute a suitability assessment for each of the potential target systems.

25. The computer program product according to claim 24, wherein the computer-readable program code means for using further comprises:
computer-readable program code means for comparing the status of each of the installation parameters to the selected values to determine the associated weight to be used for this installation parameter for this potential target system; and
computer-readable program code means for adding the determined weights to yield the computed suitability assessment for this potential target system.

26. The computer program product according to claim 24, further comprising computer-readable program code means for ranking the potential target systems according to their suitability assessments.

27. The computer program product according to claim 24, wherein the potential target systems are remotely-located.

28. A method of improving installation of software packages, comprising steps of:
assigning a weight to each of one or more selected values of one or more installation parameters associated with installation of a plurality of software products;
determining a plurality of potential target systems on which the installation of the software products might be performed;
identifying a routine to analyze each of the installation parameters;
programmatically interrogating each of the potential target systems for its status of each of the installation parameters, using the identified routines; and
using the assigned weights, in combination with the selected values and the status of each of the installation parameters, to compute a suitability assessment for each of the potential target systems.
